(19) United States
(12) Patent Application Publication
(10) Pub. No.: US 2017/0070000 A1
(43) Pub. Date: Mar. 9, 2017

(54) POWER SUPPLY EQUIPMENT OF ELECTRONIC DEVICE

(71) Applicant: Samsung Electronics Co., Ltd., Gyeonggi-do (KR)

(72) Inventors: Junhyeok SONG, Gyeonggi-do (KR); Woojung SHIM, Gyeonggi-do (KR); Daesun RHEE, Gyeonggi-do (KR); Backman KIM, Gyeonggi-do (KR); Kwangsik YANG, Gyeonggi-do (KR); Wonku YEO, Gyeonggi-do (KR); Sunghyun YOO, Seoul (KR); Seokho LEE, Gyeonggi-do (KR); Juhyup LEE, Gyeonggi-do (KR); Sunjun JANG, Daegu (KR); Hwanju JO, Gyeonggi-do (KR)

(21) Appl. No.: 15/254,025

(22) Filed: Sep. 1, 2016

(30) Foreign Application Priority Data
Sep. 9, 2015 (KR) 10-2015-0127892

(51) Int. Cl. H01R 13/62; H01R 24/38

(52) U.S. Cl. CPC H01R 13/6205; H01R 24/38; H01R 2103/00

(57) ABSTRACT

An apparatus for an electronic device is provided, comprising: a connector having an opening and mounted on the electronic device; and a plug having a hollow tip that protrudes from a distal face of the plug, the hollow tip adapted to be inserted into the opening, wherein the connector and the plug generate a magnet attraction force when the hollow tip is inserted into the opening.

### CLAIM OF PRIORITY

The present application is related to and claims benefit under 35 U.S.C. §119(a) of Korean patent application filed on Sep. 9, 2015 in the Korean Intellectual Property Office and assigned Serial number 10-2015-0127892, the entire disclosure of which is hereby incorporated by reference.

### TECHNICAL FIELD

The present disclosure relates to a power supply equipment of an electronic device.

### BACKGROUND

Electronic devices such as mobile devices and laptop computers operate on power supplied from a power source. Typically, the electronic device is connected to the power source via a power supply equipment having a power cord with an alternating current to direct current (AC/DC adapter) on one end and a power plug on the other end that connects to the electronic device.

Power coupling between a device and the power supply equipment may be classified into two types: insertion-type power coupling which connects the device and power connector mechanically, e.g. using a hook mechanism, and contact-type power coupling which connects the device and power connector using a plurality of magnets and power control lines.

In the case of the insertion-type power coupling, the connection between device and power connector is maintained by an elastic force generated from a hooking mechanism; thus, if external impact is given to the cord when the connection tip of the power plug is inserted into a receptacle of the device, for example if the device is dropped, the connection tip is likely to be broken near the device, resulting in significant damage of the receptacle of the device. Also, the cord is vulnerable to external impact at the portion close to the adapter of the power supply so that the AC/DC adapter may be damaged.

Meanwhile, the contact-type power coupling using magnetic forces has drawbacks in terms of expensive cost, necessity of a power supply and control lines, and complex structure. Insertion-type power coupling also has an advantage over the contact-type power coupling in that insertion-type power coupling provides tactile feedback to the user that an insertion has been made such that power is supplying to the electronic device.

Accordingly, there is an increasing need for protecting both the mobile device and power connector against external impacts.

### SUMMARY

The present disclosure has been conceived to solve the above problems and aims to provide a power supply equipment of an electronic device that is capable of protecting the device and cord from being damaged by allowing the power connector to be detached from the device.

In accordance with an aspect of the present disclosure, an apparatus for an electronic device is provided, comprising: a connector having an opening and mounted on the electronic device; and a plug having a hollow tip that protrudes from a distal face of the plug, the hollow tip adapted to be inserted into the opening, wherein the connector and the plug generate a magnet attraction force when the hollow tip is inserted into the opening

The connector may comprise an electrode terminal unit made of a conductive material adapted to be in contact with the hollow tip when the hollow tip is inserted into the opening; a contact housing which contains the electrode terminal unit; and a mounting bracket for mounting the contact housing on the electronic device

The electrode terminal unit may comprise a pin adapted to facilitate electrical contact between the electrode terminal unit and the hollow tip, and a patterned element integrated with the pin for coupling the contact housing to a proximal end of the pin.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a schematic view illustrating a mobile device and a power supply equipment according to one embodiment of the present disclosure;

FIG. 2 is an enlarged view of the power connector of the power supply equipment in the state of being connected to the mobile device of FIG. 1;

FIG. 3 is a perspective view illustrating the DC connector of the mobile device of FIG. 2;

FIG. 4 is a cross-sectional view illustrating the cross section of the DC connector of the mobile device of FIG. 2;

FIG. 5 is a dissembled perspective view illustrating the DC connector of the mobile device of FIG. 2;

FIG. 6 is a perspective view illustrating the plug of FIG. 2;

FIG. 7 is a cross-sectional view taken along the line B-B of FIG. 6; and

FIG. 8 is a cross-sectional view taken along the line A-A of FIG. 2.

### DETAILED DESCRIPTION

Hereinafter, the present disclosure will be described with reference to the accompanying drawings. Although specific embodiments are illustrated in the drawings and related detailed descriptions are discussed in the present specification, the present disclosure may have various modifications and several embodiments. However, various embodiments of the present disclosure are not limited to a specific implementation form and it should be understood that the present disclosure includes all changes and/or equivalents and substitutes included in the spirit and scope of various embodiments of the present disclosure. In connection with descriptions of the drawings, similar components are designated by the same reference numeral.

In various embodiments of the present disclosure, the expression “or” or “at least one of A or/and B” includes any or all of combinations of words listed together. For example, the expression “A or B” or “at least A or/and B” may include A, may include B, or may include both A and B.

The expression “1”, “2”, “first”, or “second” used in various embodiments of the present disclosure may modify various components of the various embodiments but does not limit the corresponding components. For example, the above expressions do not limit the sequence and/or importance of the components. The expressions may be used for distinguishing one component from other components. For example, a first user device and a second user device indicate different user devices although both of them are user devices. For example, without departing from the scope of the present disclosure, a first structural element may be referred to as a second structural element. Similarly, the second structural element also may be referred to as the first structural element.

The expression “configured to” uses in the present disclosure may be replaced, according to situations, with “suitable for”, “having the capacity to”, “designed to”, “adapted to”, “made to”, or “capable of”. The term “configured to” may not always mean “specially designed to”. In some situations, “device configured to” may mean that the device can “do something” with other devices or components. For example, a context “processor configured to execute A, B, and C” may mean a dedicated processor (for example, embedded processor) for executing a corresponding operation, or a generic-purpose processor (for example, CPU or application processor) capable of executing corresponding operations by using at least one software program stored in a memory device.

The terms used in the present disclosure is to merely describe a specific embodiment, and is not intended to limit the scope of other embodiments. A singular form may include a plural form. All the terms including a technical or scientific term may have the same meaning as terms generally understood by those skilled in the prior art. The terms defined in a general dictionary may be interpreted as having the same or similar meaning in a context of related technology, and are not interpreted abnormally or excessively unless clearly defined in the present disclosure. According to situations, the terms defined in the present disclosure cannot be interpreted as excluding the embodiments of the present disclosure.

Hereinafter, an electronic device according to various embodiments of the present disclosure will be described with reference to the accompanying drawings. The term “user” used in various embodiments may refer to a person who uses an electronic device or a device (for example, an artificial intelligence electronic device) which uses an electronic device.

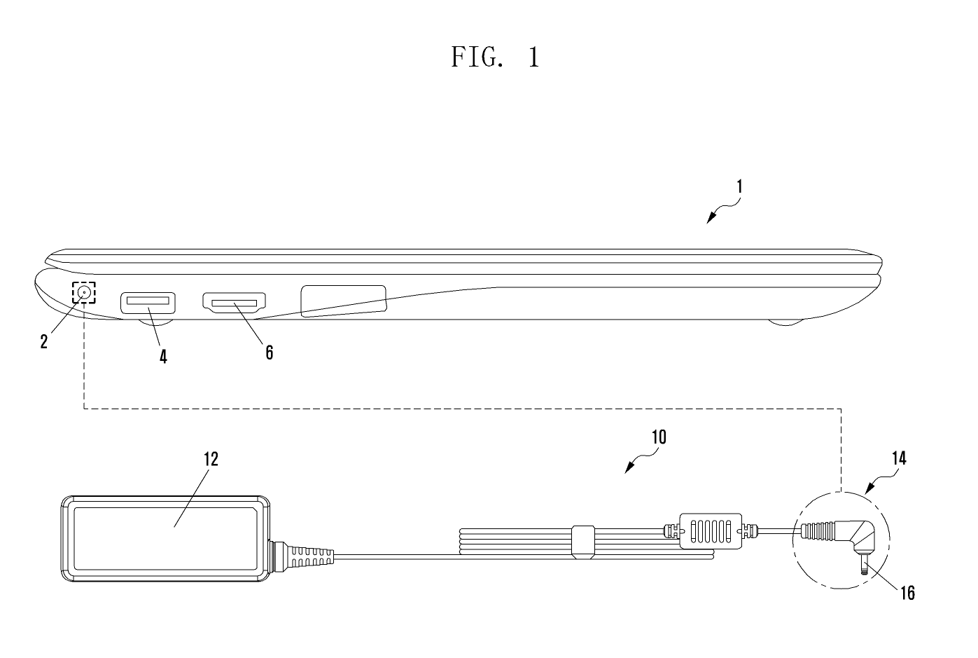

FIG. 1 is a schematic view illustrating a mobile device and a power supply equipment according to one embodiment of the present disclosure.

In the embodiment of FIG. 1, the mobile device is a laptop computer 1 which is provided with a detachable power supply equipment 10.

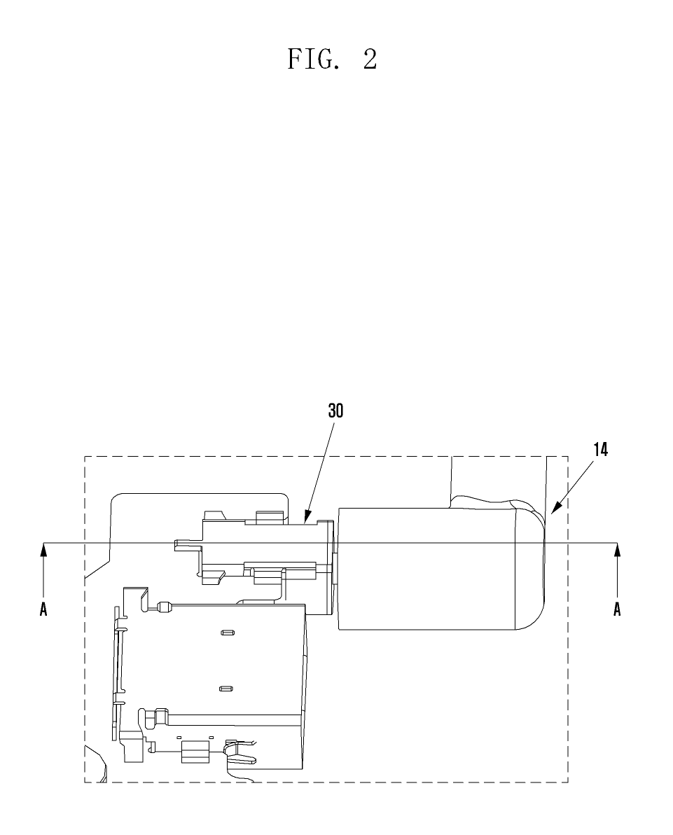

According to various embodiments of the present disclosure, the laptop computer 1 includes a power jack 2, a Universal Serial Bus (USB) port 4, and a High Definition Multimedia Interface (HDMI) port 6 formed on one side thereof and operates on power supplied from a power source via the power supply equipment 10 which is connected to the power jack 2. The power jack 2 may be a part of a Direct Current (DC) connector 30, shown in FIG. 2.

Typically, the power supply equipment 10 includes an AC/DC adapter 12 and a plug 14 connected at both ends of a cord, the hollow tip 16 of the plug 14 is formed so that it can be inserted into the power jack 2 of the laptop 1, and an extra power cable (not shown) of which one end is connected to the power source, such as a wall outlet, may be connected to the adapter on the other end.

FIG. 2 is an enlarged view of the power connector, such as plug 14, of the power supply equipment in the state of being connected to the mobile device of FIG. 1, such as being connected to power jack 2.

As shown in FIG. 2, the laptop 1 may be connected to the power source in such a way that the hollow tip 16 of the plug 14 is inserted into the power jack 2 of the DC connector 30 of the laptop 1 when the adapter 12 is connected to the power source via a separate power cable, for example when adapter 12 is connected by the separate power cable to a wall outlet.

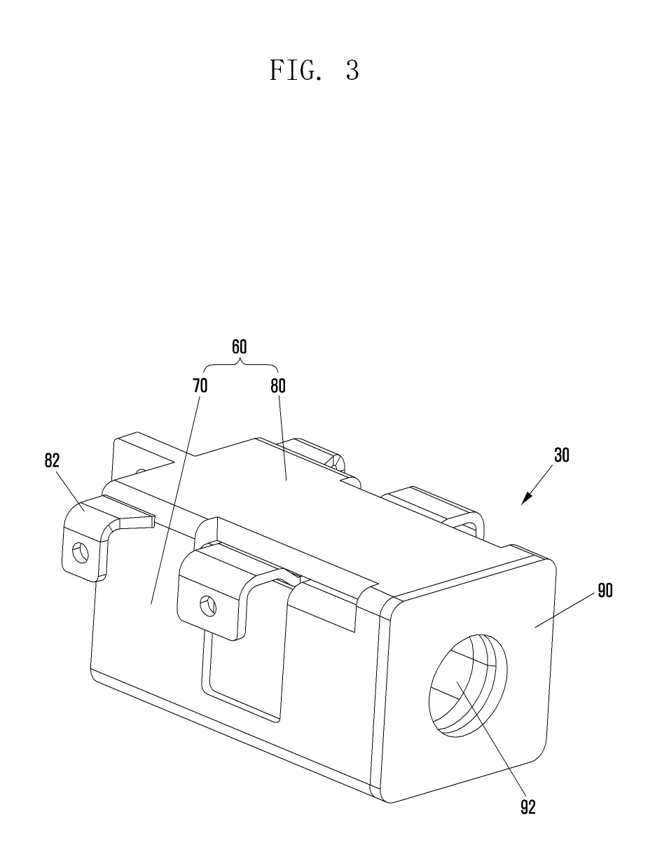

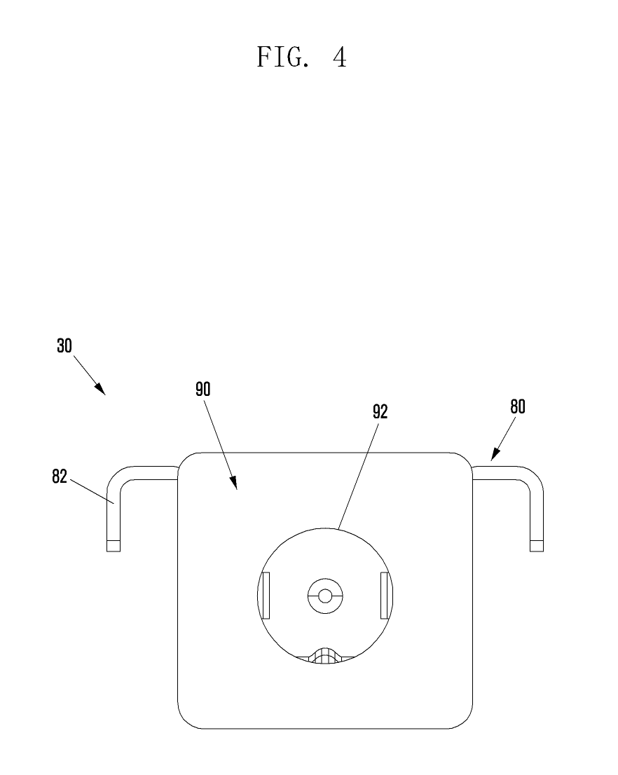

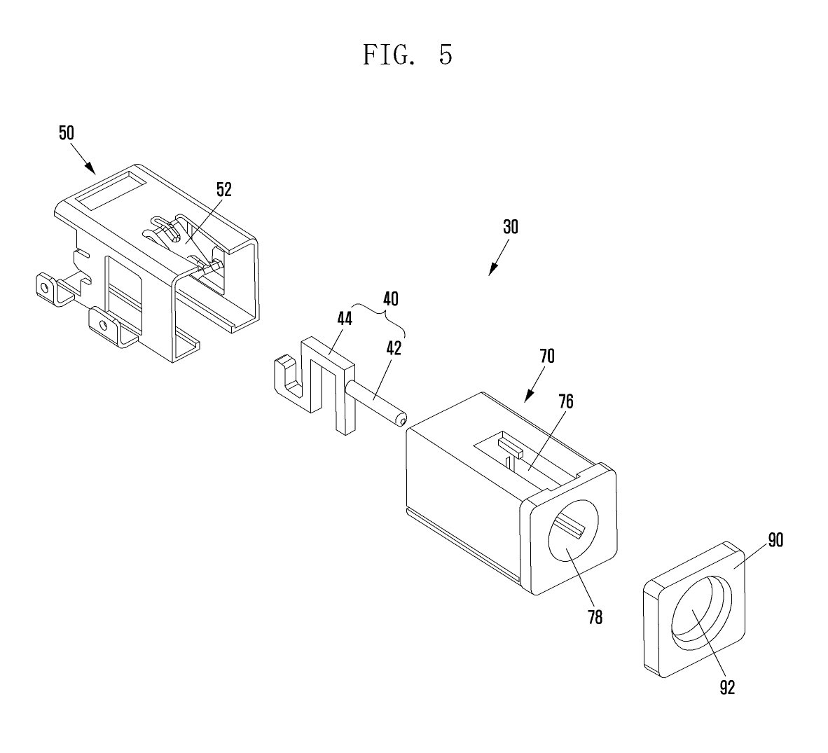

FIG. 3 is a perspective view illustrating the DC connector of the mobile device of FIG. 2, FIG. 4 is a cross-sectional view illustrating the cross section of the DC connector of the mobile device of FIG. 2, and FIG. 5 is a dissembled perspective view illustrating the DC connector of the mobile device of FIG. 2.

Referring to FIGS. 3 to 5, the DC connector 30 may include an electrode terminal unit 40 made of a conductive material which allows the power jack 2 to receive power from the hollow tip 16 of the plug 14, a contact housing 50 in which the electrode terminal unit 40 is situated, and a mounting bracket 60 for mounting the contact housing 50 on the laptop 1 according to one embodiment of the present disclosure.

The electrode terminal unit 40 may include a pin 42 that can be coupled with the hollow tip 16 of the plug 14, i.e. inserted into the hollow portion of the hollow tip 16 and a patterned element 44 at one end of a pin 42 that is integrated with the pin 42.

The contact housing 50 may have a hooking element 52 formed in a curved shape to generate elastic force so as to maintain a connection between the hollow tip 16 of the plug 14 and the pin 42 of the electrode terminal unit.

According to an embodiment, the hooking element 52 is curved such that its one end is oriented to form a slope, which facilitates coupling the hollow tip 16 of the plug 14 with the power jack 2 so that electricity can conduct between the pin 42 of the electrode terminal unit 40 and the hollow tip 16 of the plug 14.

The mounting bracket 60 may include a body 70 in which the electrode terminal unit 40 and the contact housing 50 are mounted and a coupling unit 80 which is connected with the body 70 to cover the top side of the coupling unit 80 and has coupling pieces 82 on both sides to couple the mounting bracket 60 with the laptop 1. The coupling unit 80 of the mounting bracket 60 is omitted in FIG. 5.

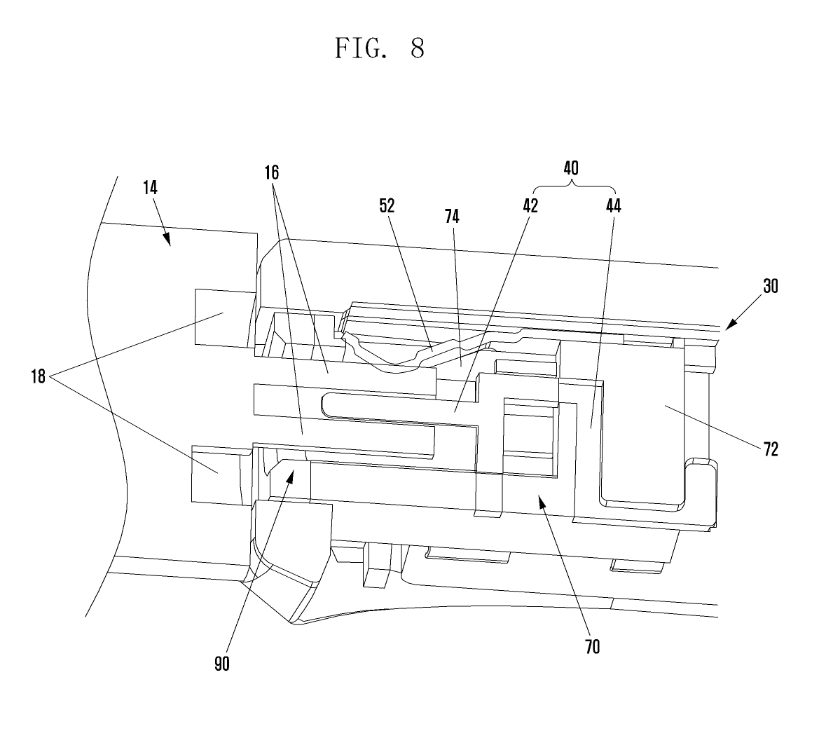

As shown in FIG. 8, the body 70 may include a hollow space 74 where a pattern coupler 72 corresponding in shape to a part of the patterned element 44 of the electrode terminal unit 40 and the pin 42 corresponding in shape to the remaining part of the patterned element 44 of the electrode terminal unit 40, so that the pin 42 is exposed. The body 70 may also include an opening 76 in which the hooking element 52 of the contact housing 50 is inserted and another opening 78 is formed to receive the hollow tip 16 of the plug 14.

A distal end plate 90 which may be made of a strong magnetic material or magnet and having a hole 92 coaxial with the opening 78 to allow for the hollow tip 16 of the plug 14 to pass through is mounted on the distal end surface of the body 70 of the mounting bracket 60.

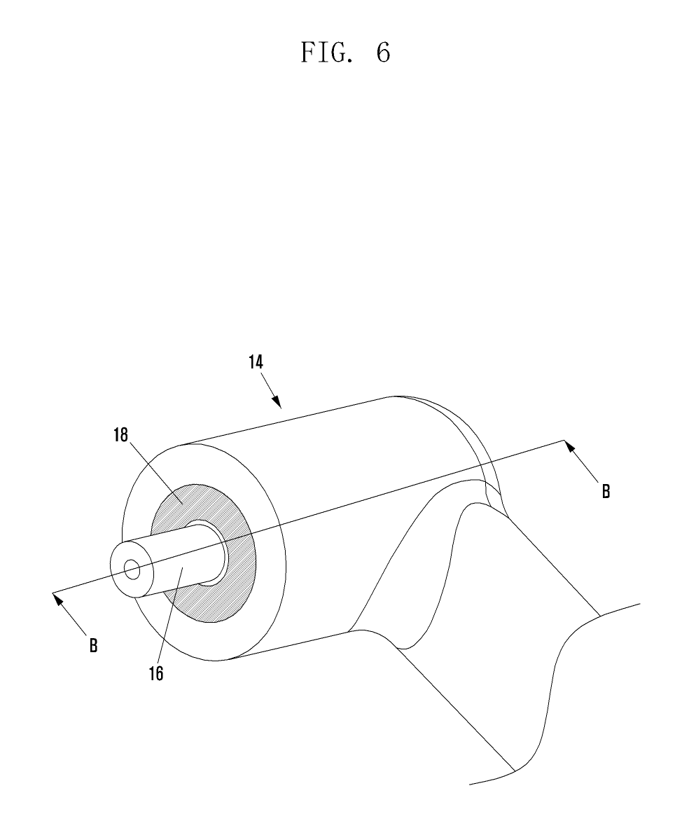

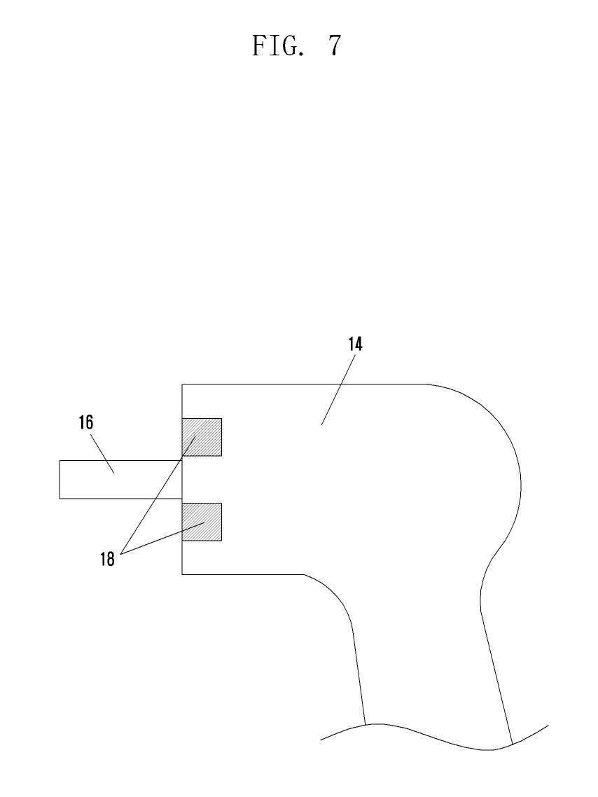

FIG. 6 is a perspective view illustrating the plug of FIG. 2, and FIG. 7 is a cross-sectional view taken along the line B-B of FIG. 6.

Referring to FIGS. 6 and 7, the plug 14 has a cylindrical cross-section such that the hollow tip 16 is arranged coaxially with the cylindrical plug 14. The hollow tip 16 protrudes from a distal face 18 of the plug 14. The distal face 18 may be made with a magnet or magnetic material with an opposite polarity than that of the distal end plate 90.

According to an embodiment of the present disclosure, when the hollow tip 16 is inserted into the opening 78, the distal face 18 of the plug 14 and the distal end plate 90 of the DC connector may generate a magnetic force to keep the hollow tip in place. Since the distal face 18 is formed inside the plug 14 of the power supply equipment 10 of the present disclosure so as to be attracted to the distal end plate 90 bonded at the end of the power jack 2 of the mobile device, it is possible to shorten the length of the hollow tip of the plug in comparison with a conventional plug.

For example, if the length of the hollow tip of the conventional plug is about 9-10 mm and the length of the pin 42 of the electrode terminal unit 40 is about 6-7 mm, the hollow tip 16 of the plug 14 can be tightly coupled with the mobile device by wholly inserting the pin 42 of the electrode terminal unit 40 into the center hole of the hollow tip of the plug.

According to one embodiment of the present disclosure, however, it may be possible to shorten the length of the hollow tip 16 of the plug 14 up to a length of 4 mm. If the pin 42 is inserted as deep as 3 mm into the hollow tip 16 having the length of 4 mm so that a margin of 1 mm remains, it is difficult to secure enough coupling force between the hollow tip 16 of the plug 14 and the mobile device. This is because the elastic force generated by the hooking element 52 is insufficient. However, the power supply equipment 10 of the present disclosure is capable of compensating for the lack of coupling elastic force with the magnetic force between the distal end plate 90 and the magnetic distal face 18.

According to various embodiments of the present disclosure, the distal end plate 90 and the magnetic distal face 18 may be replaced by a permanent magnetic substance or electromagnetic substance.

The power supply equipment 10 of the present disclosure is capable of preventing the mobile device and cable from being damaged especially when the plug 14 is disconnected by an external impact when the DC connector 30 of the mobile device and the plug 14 are connected each other with the assistance of the magnetic force.

According to various embodiments, the coupling mechanism of the magnetic distal face 18 may also be used between the AC/DC adapter 12 and an extra power cable (not shown) connected to the power source, such as a wall outlet, in order for the adapter 12 and the power cable to be disconnected easily to protect against the external impact applied thereto.

According to an embodiment, if the magnetic distal face 18 has a polarity of N, the distal end plate 90 made of a strong magnetic substance or magnet may have a polarity of S. The polarities of the magnetic distal face 18 and the distal end plate 90 may be changed oppositely.

Descriptions are made hereinafter of the operations of the power supply equipment of the electronic device, which is configured as above according to various embodiments of the present disclosure, with reference to FIG. 8.

As shown in FIG. 8, if the hollow tip 16 of the plug 14 of the power supply equipment 10 of the present disclosure is inserted into the power jack 2 of the laptop 1, the hollow tip 16 of the plug 14 penetrating the hole 92 of the distal end plate and the opening 78 of the body 70 of the mounting bracket 60 pushes the hooking element 52 upward in progress while the magnetic distal face 18 of the plug 14 and the distal end plate 90 attract each other to contact due to their magnetism such that the plug 14 is coupled with the DC connector 30 in the state that the pin 42 of the electrode terminal unit 40 is inserted into the hollow tip 16 of the plug 14.

The elastic force of the pushed hooking element 52 which applied to the hollow tip 16 and the magnetism between the magnetic distal face 18 of the plug 14 and the distal end plate 90 may make it possible to maintain the connection between the power cable and the mobile device.

In this state, if an external impact is applied to the mobile device or the power cable, the shortened hollow tip is easily separated from the DC connector 30 to release the magnetic hold between the plug 14 and the DC connector and thus prevent the external impact from propagating to the mobile device or the cable, which results in preventing the mobile device and cable from being damaged.

An electronic device according to various embodiments of the present disclosure may be a device including a projection function. For example, the electronic device may be one or a combination of a smart phone, a tablet Personal Computer (PC), a mobile phone, a video phone, an e-book reader, a desktop PC, a laptop PC, a netbook computer, a Personal Digital Assistant (PDA), a camera, a wearable device (for example, a Head-Mounted-Device (HMD) such as electronic glasses, electronic clothes, and electronic bracelet, an electronic necklace, an electronic appcessary, an electronic tattoo, and a smart watch.

According to some embodiments, the electronic device may be a smart home appliance having a projection function. The smart home appliance may include at least one of a TeleVision (TV), a Digital Video Disk (DVD) player, an audio player, an air conditioner, a cleaner, an oven, a microwave oven, a washing machine, an air cleaner, a set-top box, a TV box (for example, Samsung HomeSync™, Apple TV™, or Google TV™), game consoles, an electronic dictionary, an electronic key, a camcorder, and an electronic frame.

According to some embodiments, the electronic device may include at least one of various types of medical devices (for example, Magnetic Resonance Angiography (MRA), Magnetic Resonance Imaging (MRI), Computed Tomography (CT), a scanner, an ultrasonic device and the like), a navigation device, a Global Positioning System (GPS) receiver, an Event Data Recorder (EDR), a Flight Data Recorder (FDR), a vehicle infotainment device, electronic equipment for a ship (for example, a navigation device for ship, a gyro compass and the like), avionics, a security device, a head unit for a vehicle, an industrial or home robot, an Automatic Teller Machine (ATM) of financial institutions, and a Point Of Sale (POS) device of shops.

According to some embodiments, the electronic device may include at least one of furniture or a part of a building/structure, an electronic board, an electronic signature receiving device, a projector, and various types of measuring devices (for example, a water meter, an electricity meter, a gas meter, a radio wave meter and the like) including a projection function. The electronic device according to various embodiments of the present disclosure may be one or a combination of the above described various devices. Further, the electronic device according to various embodiments of the present disclosure may be a flexible device. It is apparent to those skilled in the art that the electronic device according to various embodiments of the present disclosure is not limited to the above described devices.

According to various embodiments, the electronic device may be any or a combination of the aforementioned various devices. In an embodiment, the electronic device may be a flexible electronic device. The electronic device is not limited to the aforementioned devices but may be any devices emerging newly in the future in line with the advance of technologies.

As described above, the power supply equipment of the electronic device according to various embodiments of the present disclosure is advantageous in terms of reinforcing the coupling force between the power cable and the mobile device with the assistance of magnetic attraction force even in case the hollow tip of the plug is shortened in comparison with the legacy plugs by adding a strong magnetic substance or a magnet around the hole receiving the hollow tip and in terms of preventing the mobile device and cable from being damaged by allowing the plug to be easily separated from the connector.

The exemplary embodiments disclosed in the specification and drawings are merely presented to easily describe technical contents of the present disclosure and help the understanding of the present disclosure and are not intended to limit the scope of the present disclosure. Therefore, all changes or modifications derived from the technical idea of the present disclosure as well as the embodiments described herein should be interpreted as belonging to the scope of the present disclosure.

What is claimed is:

1. An apparatus for an electronic device, comprising:
a connector having an opening and mounted on the electronic device; and
a plug having a hollow tip that protrudes from a distal face of the plug, the hollow tip adapted to be inserted into the opening,
wherein the connector and the plug generate a magnet attraction force when the hollow tip is inserted into the opening.

2. The apparatus of claim 1, wherein the connector further including a distal end plate disposed at a distal end of the opening, the distal end plate having a first magnetic polarity and having a hole for receiving the hollow tip, the distal face of the plug having a second magnetic polarity opposite of the first magnetic polarity,
wherein when the hollow tip is inserted into the connector, the distal face of the plug and the distal end plate of the connector generate the magnetic attraction force.

3. The apparatus of claim 1, wherein the connector further including a hooking element disposed adjacent to the opening, the hooking element having a curved shape to generate an elastic force between the connector and the hollow tip when the hollow tip is inserted into the connector.

4. The apparatus of claim 1, wherein the connector includes a hooking element disposed adjacent to the opening, the hooking element having a curved shape to generate an elastic force between the connector and the hollow tip when the hollow tip is inserted into the connector.

5. The apparatus of claim 3, wherein the elastic force and the magnetic attraction force substantially maintain an electrically conductive contact between the connector and the hollow tip.

6. The apparatus of claim 1, wherein the connector further comprises:
an electrode terminal unit made of a conductive material adapted to be in contact with the hollow tip when the hollow tip is inserted into the opening;
a contact housing which contains the electrode terminal unit; and
a mounting bracket for mounting the contact housing on the electronic device.

7. The apparatus of claim 5, wherein the mounting bracket further comprises a body in which the electrode terminal unit and the contact housing are mounted and a coupling unit which is connected to the body that includes coupling pieces protruded from the body for coupling the mounting bracket to the electronic device.

8. The apparatus of claim 5, wherein the electrode terminal unit further comprises a pin adapted to facilitate electrical contact between the electrode terminal unit and the hollow tip, and a patterned element integrated with the pin for coupling the contact housing to a proximal end of the pin.

9. The apparatus of claim 7, wherein the pin is at least partially inserted into the hollow tip of the plug.

10. The apparatus of claim 3, wherein the hooking element has an end that forms a slope.

11. The apparatus of one of claim 7, wherein the mounting bracket further comprises a pattern coupler corresponding in shape to a part of the patterned element, such that the pin and the patterned element is coupled to the mounting bracket via the pattern coupler.

12. The apparatus of claim 2, wherein both the distal end plate and the distal face of the plug are made of a permanent magnetic substance or electromagnetic substance.

13. The apparatus of claim 1, wherein the plug is connected to a power supply via a first cord, and the power supply includes a second cord adapted to be magnetically attached to the power supply.
